(19) United States
(12) Patent Application Publication
(10) Pub. No.: US 2025/0300484 A1
(43) Pub. Date: Sep. 25, 2025

(54) POWER MANAGEMENT CIRCUIT

(71) Applicant: Chengdu Monolithic Power Systems Co., Ltd., Chengdu (CN)

(72) Inventor: Bo Li, Chengdu (CN)

(21) Appl. No.: 19/083,152

(22) Filed: Mar. 18, 2025

(30) Foreign Application Priority Data
Mar. 19, 2024 (CN) 202410315847.2

(51) Int. Cl. H02J 7/34; H02J 7/00

(52) U.S. Cl. CPC H02J 7/345; H02J 7/0047; H02J 7/0068; H02J 2207/20

(57) ABSTRACT

A power management circuit at least comprises two charging paths, one of which is a pre-charge circuit coupled between a bus terminal and a storage terminal, and another is a switch charging circuit coupled between the bus terminal and the storage terminal. The power management circuit has at least a common operation mode and a bypass mode. In the common operation mode, the pre-charge circuit is only enabled during partial of the charging period, and in the bypass mode, the pre-charge circuit is enabled during entire charging period. The power management circuit of the present disclosure therefore has good adaptability and can be compatible with design schemes with different storage capacitor selection preferences.

### CROSS-REFERENCE TO RELATED APPLICATIONS

The present application claims priority to, and the benefit of, Chinese Application No. 202410315847.2 filed on Mar. 19, 2024, which is incorporated herein by reference in its entirety.

### TECHNICAL FIELD

The present disclosure relates to electronic circuits, in particular but not limited to a power management circuit.

### BACKGROUND

Power management circuit including a power conversion circuit and storage capacitor(s) may have a power storage function. Generally, the power conversion circuit charges the storage capacitor(s) to have energy stored for example in the form of an energy storage voltage to reach a preset storage value, so that when a power loss occurs in a system where the power management circuit is located, the energy stored in the storage capacitor(s) can be used as a backup power supply to provide power.

The storage capacitor(s) can be selected from a variety type of capacitors such as an electrolytic capacitor, a stacked capacitor, a tantalum capacitor, a double-layer capacitor, a polymer capacitor, or a battery. The preset storage value can be calculated based on an amount of energy required to be stored and the selection of the capacitor(s). In some typical applications, users choose electrolytic capacitors as storage capacitors, and the preset storage value is usually higher than a bus voltage of the power management circuit. In some other applications, users choose other capacitors (such as supercapacitors) as storage capacitors, and the preset storage value may be lower than the bus voltage of the power management circuit. It is necessary to provide a power management circuit that can charge the capacitor(s) regardless of whether the preset storage value determined by the capacitor selection is lower than or higher than the bus voltage and convert the storage voltage to the bus voltage when an input voltage of the power management circuit normally received from an external power source is power loss (e.g., power failure or disconnection from the external power source occurs).

### SUMMARY

Purpose of the present disclosure is to provide a power management circuit.

The power management circuit according to the present disclosure includes a bus terminal for providing a bus voltage and a storage terminal for providing a charging current. It also includes a receiving terminal configured for receiving a sensing signal indicative a storage voltage at the storage terminal. The power management circuit has a common operation mode and a bypass mode. The power management circuit is configured to convert the storage voltage to a first storage preset value in its common operation mode and to convert the storage voltage to a second storage preset value in its bypass mode, wherein the first storage preset value is higher than the bus voltage, and the second storage preset value is lower than the bus voltage.

The power management circuit according to the present disclosure includes a bus terminal for providing a bus voltage and a storage terminal for providing a charging current. The power management circuit also includes a pre-charge circuit coupled between the bus terminal and the storage terminal and a switching circuit coupled between the bus terminal and the storage terminal. The power management circuit includes a receiving terminal, which is configured for receiving a sensing signal indicative a storage voltage at the storage terminal. The power management circuit also includes a voltage comparator coupled between the receiving terminal and the pre-charge circuit.

The power management circuit according to the present disclosure includes a bus terminal for providing a bus voltage and a storage terminal for providing a charging current. The voltage at the storage terminal can be characterized by a sensing signal. The receiving terminal is configured to receive the sensing signal. The power management circuit also includes a pre-charge circuit coupled between the bus terminal and the storage terminal, and a switching circuit coupled between the bus terminal and the storage terminal. The power management circuit has a common operation mode and a bypass mode. In the common operation mode, the pre-charge circuit is enabled during a partial charging period, and in the bypass mode, the pre-charge circuit is enabled during an entire charging period.

### BRIEF DESCRIPTION OF DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 shows a schematic diagram of a power management circuit 100 in accordance with an embodiment of the present disclosure.

FIG. 2 shows an illustrative waveform diagram of a storage voltage of a power management circuit in a common operation mode according to an embodiment of the present disclosure.

FIG. 3 is a schematic diagram of a power management circuit 100 during a pre-charge period of the common operation mode according to an embodiment of the present disclosure.

FIG. 4 is a schematic diagram of a power management circuit 100 during switch charging period in a common operation mode according to an embodiment of the present disclosure.

FIG. 5 is a schematic diagram of a waveform of a storage voltage of a power management circuit 100 in a bypass mode according to an embodiment of the present disclosure.

FIG. 6 is a schematic diagram of a power management circuit 100 during charging period in bypass mode according to an embodiment of the present disclosure.

The same reference numerals in different schematic figures indicate the same or similar parts or features.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in an embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Although some embodiments of the present disclosure have been described in detail above, it should be understood that these embodiments are only for illustrative purposes and are not used to limit the scope of the present disclosure. Other feasible alternative embodiments can be known to those of ordinary skill in the art by reading the present disclosure.

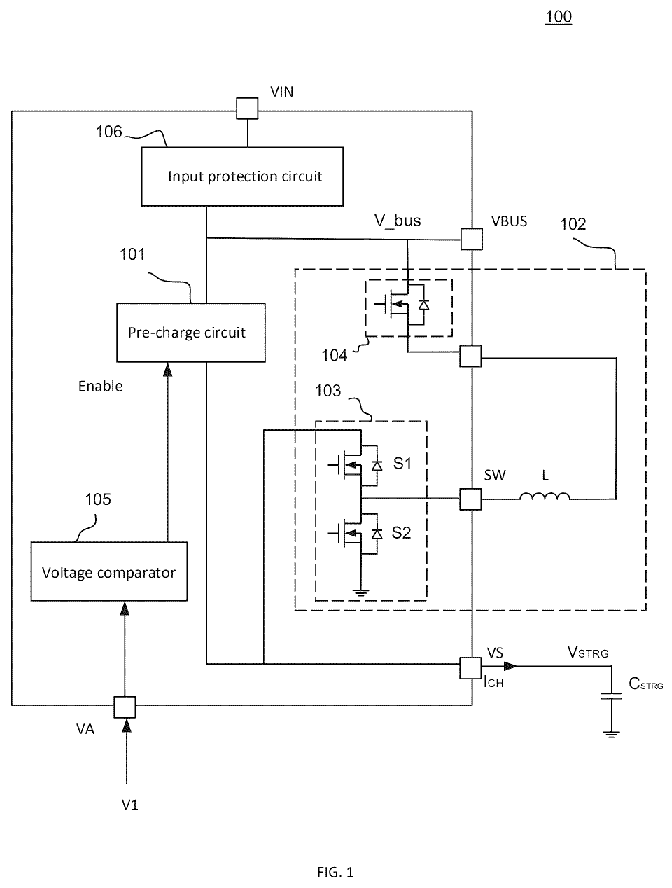

FIG. 1 shows a schematic diagram of a power management circuit 100 in accordance with an embodiment of the present disclosure. As shown in FIG. 1, in one embodiment, the power management circuit 100 comprises a bus terminal VBUS, a storage terminal VS, a receiving terminal VA. The bus terminal VBUS is configured as an output terminal to output a bus voltage V_bus. The storage terminal VS is configured as an output terminal that is adapted to be coupled to a storage capacitor C_{STRG}. The storage terminal VS in an embodiment may transmit a charging current. The charging current is used to charge the storage capacitor C_{STRG}. The receiving terminal VA is coupled to the storage capacitor C_{STRG} and configured as an input terminal to receive a sensing signal V1. The sensing signal V1 indicative a storage voltage of the storage capacitor C_{STRG}.

In one embodiment, one of the functions of the power management circuit 100 is to provide a current from the bus terminal VBUS to the storage terminal to charge the storage capacitor C_{STRG}. There are at least two current paths, one is a pre-charge circuit 101 between the bus terminal VBUS and the storage terminal VS, another is a switch charging circuit 102 between the bus terminal VBUS and the storage terminal VS. The pre-charge circuit 101 is configured to provide a charging current I_{CH} to charge the storage capacitor C_{STRG}. As shown in FIG. 1, in an implementation the switch charging circuit 102 includes a switching circuit 103, the switching circuit 103 comprises a first switch S1 and a second switch S2. The first switch S1 comprises a first terminal and a second terminal, the first terminal of the first switch S1 is coupled to the storage terminal VS. The second switch S2 comprises a first terminal and a second terminal, the second terminal of the second switch S2 is coupled to the ground. The second terminal of the first switch S1 and the first terminal of the second switch S2 are coupled to form a common terminal SW of the switching circuit 103. The common terminal SW is coupled to an inductive element L. The switch charging circuit 102 can be configured as a boost converter to transfer a bus voltage V_bus to a storage voltage V_{STRG}, or configured as a buck converter to transfer a storage voltage V_{STRG} to the bus voltage V_bus.

In an embodiment, as shown in FIG. 1, the switch charging circuit 102 includes a blocking transistor 104 coupled between the bus terminal VBUS and the inductive element L. In an implementation, the blocking transistor 104 is coupled between the first switch S1 and the storage terminal VS. The parasitic diode of the blocking transistor 104 is configured back-to-back with the parasitic diode of the first switch S1.

In an embodiment, as shown in FIG. 1, the pre-charge circuit 101 and the switch charging circuit 102 are independent. But in another implementation, the pre-charge circuit 101 and the switch charging circuit 102 may have multiplexed components, that is, the multiplexed components are parts of the pre-charge circuit 101 and parts of the switch charging circuit 102 also.

In present disclosure, the power management circuit includes a common operation mode and a bypass mode. In the common operation mode, the pre-charge circuit 101 is configured to be enabled during a partial charging period, and in the bypass mode, the pre-charge circuit 101 is configured to be enabled throughout the entire charging period.

In one embodiment, the power management circuit 100 includes a voltage comparator 105 coupled between the receiving terminal VA and the pre-charge circuit 101. In an implementation, the power management circuit 100 includes an input terminal VIN configured to receive an input voltage. In an implementation, the power management circuit 100 also includes an input protection circuit 106 coupled between the input terminal VIN and the bus terminal VBUS.

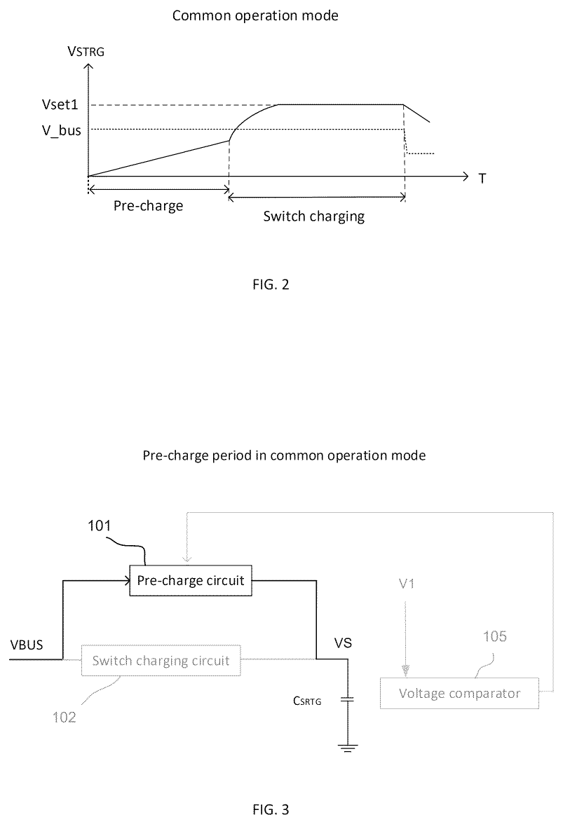

As mentioned above, the power management circuit 100 comprises a common operation mode and a bypass mode at least. The pre-charge circuit 101 and the switch charging circuit 102 can work together in different way in corresponding mode. FIG. 2-FIG. 6 show examples of the way that the power management circuit 100 operating, according to an embodiment of the present disclosure.

The power management circuit 100 of the present disclosure can operate in the common operation mode if a preset storage voltage depended on the capacitor chosen by the user is higher than the bus voltage V_bus. In an implementation, the voltage comparator 105 is disabled in the common operation mode. As shown in FIG. 2, in the common operation mode, an entire charging period includes a pre-charge period and a switch charging period at least.

As shown in FIG. 2, in an embodiment, the common operation mode includes a pre-charge period during which the storage voltage rises to a pre-charge voltage at a preset slope. As shown in FIG. 3, in an embodiment, during the pre-charge period in the common operation mode, the pre-charge circuit 101 is enabled while the switch charging circuit 102 is disabled (or in an implementation, as shown in FIG. 1 the switching circuit 103 is disabled). The pre-charge circuit 101 is configured to provide a charging current I_{CH} from the bus terminal VBUS to the storage terminal VS. The pre-charge period ended when the storage voltage V_{STRG} rises to or near to the bus voltage V_bus. As an example, as shown in FIG. 2, the pre-charge period is end when the storage voltage rises near to the bus voltage V_bus.

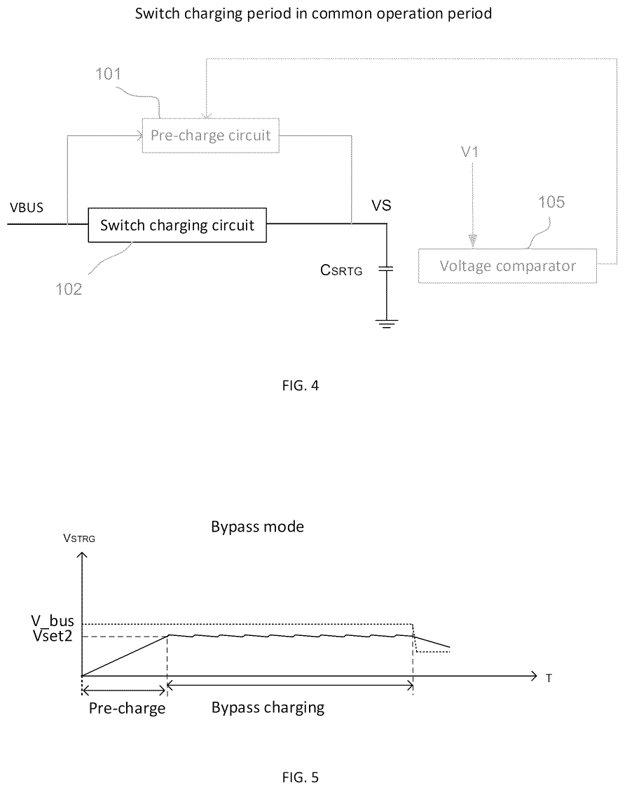

Further referring to FIG. 2, the common operation mode includes a switch charging period in which the storage voltage converted into a first storage preset value at a changing slop and maintain at the first storage preset value. Referring to FIG. 4, in an implementation, during the switch charging period in the common operation mode, the pre-charge circuit 101 is disabled while the switch charging circuit 102 is enabled (or in an implementation, the switching circuit 103 is enabled, as shown in FIG. 1). The switching circuit 103 works as a boost converter to convert the bus voltage V_bus into the first storage preset value Vset1. In the common operation mode, in case of system power loss, the switching circuit 103 is configured to convert the storage voltage V_{STRG} Which is maintained at the first storage preset value Vset1 into the bus voltage V_bus.

The power management circuit 100 of the present disclosure can operate in the bypass mode if a preset storage voltage depended on the capacitor chosen by the user is lower than the bus voltage V_bus. As shown in FIG. 5, in an implementation, an entire charging period includes a pre-charge period and a bypass charging period. The switch charging circuit 102 is disabled during the entire charging period in the bypass mode (or in an implementation, as shown in FIG. 1 the switching circuit 103 is disabled).

Further referring to FIG. 5, the bypass mode includes a pre-charge period during which the storage voltage rises to a second storage preset value Vset2 at a preset slope. During the pre-charge period in the bypass mode, the pre-charge circuit 101 is configured to provide a charging current I_{CH} from the bus terminal VBUS to the storage terminal VS to convert the storage voltage V_{STRG} into the second storage preset value Vset2 which is lower than the bus voltage V_bus.

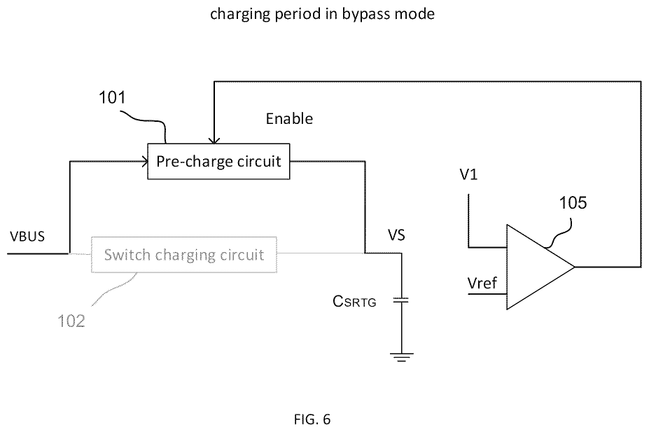

Still referring to FIG. 5, the bypass mode includes a bypass charging period during which the storage voltage is maintained at the second storage preset value Vset2. In other embodiment, maintaining the second storage preset value Vset2 means that the storage voltage fluctuates around the second storage preset value Vset2, that is, the difference between the storage voltage and the second storage preset value Vset2 is within a preset range. Referring to FIG. 6, in the bypass mode, the voltage comparator 105 receives the sensing signal V1 indicative the storage voltage V_{STRG} and compares the sensing signal V1 with a reference voltage Vref, and generates an enable signal Enable for controlling the pre-charge circuit 101 based on the voltage comparison result. When the enable signal Enable is in a first logic state (e.g., logic high), the pre-charge circuit 101 is enabled to provide a charging current I_{CH} from the bus terminal VBUS to the storage terminal VS, and when the enable signal Enable is in a second logic state (e.g., logic low), the pre-charge circuit 101 is disabled.

In one embodiment, the voltage comparator 105 comprises a hysteresis comparator, the hysteresis comparator is configured to have a first input terminal receiving the sensing signal V1 indicative the storage voltage V_{STRG}, a second input terminal receiving the reference voltage Vref, an output terminal coupled to the pre-charge circuit 101.

In the bypass mode, when the system is power loss, the switch charging circuit 102 (or, as shown in FIG. 1, the switching circuit 103) is configured to convert the storage voltage V_{STRG} maintained at the second storage preset value Vset2 into the bus voltage V_bus.

It can be seen that the power management circuit 100 has a common operation mode and a bypass mode. the power management circuit 100 is configured to convert the storage voltage into a first storage preset value Vset1 in its common operation mode, and to convert the storage value into a second storage preset value Vset2 in its bypass mode, wherein the first storage preset value Vset1 is higher than the bus voltage V_bus, and the second storage preset value is lower than the bus voltage V_bus. The power management circuit 100 determines to operate in the common operation mode or the bypass mode according to the storage capacitor C_{STRG} coupled to the storage terminal. The beneficial technical effect of the above embodiments is that the power management circuit 100 has good adaptability and is compatible with a variety of design options for selecting storage capacitors.

Although the present disclosure has been described with reference to several typical embodiments, it should be understood that the terms used are illustrative and exemplary, rather than restrictive. Since the present invention can be embodied in a variety of forms without departing from the spirit or essence of the invention, it should be understood that the above embodiments are not limited to any of the foregoing details, but should be interpreted broadly within the spirit and scope defined by the appended claims, so all changes and modifications falling within the scope of the claims or their equivalents should be covered by the appended claims.

1. A power management circuit comprising:
a bus terminal, configured as an output terminal adapted to provide a bus voltage;
a storage terminal, configured as an output terminal adapted to provide a charging current;
a receiving terminal, configured as an input terminal adapted to receive a sensing signal indicative of a storage voltage at the storage terminal;
a pre-charge circuit, configured to be coupled between the bus terminal and the storage terminal;
a switching circuit, configured to be coupled between the bus terminal and the storage terminal; and
a voltage comparator, configured to be coupled between the receiving terminal and the pre-charge circuit.

2. The power management circuit according to claim 1, wherein a common terminal of the switching circuit is coupled to the bus terminal through an inductive element.

3. The power management circuit according to claim 1, wherein the storage terminal is configured to couple to a storage capacitor.

4. The power management circuit according to claim 1, wherein the power management circuit is configured to have a common operation mode, and wherein the voltage comparator is configured to be disabled in the common operation mode.

5. The power management circuit according to claim 1, wherein the power management circuit is configured to have a common operation mode, and wherein during a charging period in the common operation mode, the switching circuit is configured to be disabled, and the pre-charge circuit is configured to provide the charging current from the bus terminal to the storage terminal.

6. The power management circuit according to claim 1, wherein the power management circuit is configured to have a common operation mode, during a switch charging period in the common operation mode, the pre-charge circuit is configured to be disabled, the switching circuit is configured to provide the charging current form the bus terminal to the storage terminal.

7. The power management circuit according to claim 1, wherein the power management circuit is configured to have a bypass mode, during both a pre-charge period and a bypass charging period in the bypass mode, the switching circuit is configured to be disabled.

8. The power management circuit according to claim 1, wherein the power management circuit is configured to have a bypass mode, during a bypass charging period in the bypass mode, the voltage comparator is configured to compare the sensing signal with a reference voltage and generate an enable signal based on the comparison result for controlling the pre-charge circuit.

9. The power management circuit according to claim 1, wherein the power management circuit is configured to have a bypass mode, during a bypass charging period in the bypass mode, the pre-charge circuit is configured to receive an enable signal generated by the voltage comparator and provide the charging current from the bus terminal to the storage terminal based on the enable signal.

10. A power management system comprising:
a bus terminal, configured as an output terminal adapted to provide a bus voltage;
a storage terminal, configured as an output terminal adapted to provide a charging current;
a receiving terminal, configured as an input terminal adapted to receive a sensing signal indicative a storage voltage at the storage terminal;
a pre-charge circuit, configured to be coupled between the bus terminal and the storage terminal;
a switching circuit, configured to be coupled between the bus terminal and the storage terminal;
the power management circuit is configured to have a common operation mode and a bypass mode, in the common operation mode, the pre-charge circuit is configured to be enabled during partial charging period, and in the bypass mode, the pre-charge circuit is configured to be disabled during entire charging period.

11. The power management circuit according to claim 10, wherein when the power management circuit operate in bypass mode, the switching circuit is configured to be disabled during entire charging period.

12. The power management circuit according to claim 10, wherein the power management circuit further includes a voltage comparator coupling between the receiving terminal and the pre-charge circuit.

13. The power management circuit according to claim 10, wherein when the power management circuit operate in bypass mode, during the entire charging period, the voltage comparator is configured to compare the sensing signal with a reference voltage and generate an enable signal based on the comparison result for controlling the pre-charge circuit.

14. A power management system comprising:
a bus terminal, configured as an output terminal adapted to provide a bus voltage;
a storage terminal, configured as an output terminal adapted to provide a charging current;
a receiving terminal, configured as an input terminal adapted to receive a sensing signal indicative a storage voltage at the storage terminal;
the power management circuit is configured to have a common operation mode and a bypass mode;
the power management circuit is configured to convert the storage voltage into a first storage preset value in the common operation mode and convert the storage voltage into a second storage preset value in the bypass mode, wherein the first storage preset value is higher than the bus voltage, and the second storage preset value is lower than the bus voltage.

15. The power management circuit according to claim 14, wherein the power management circuit is configured to determine to operate in the common operation mode or the bypass mode according to the capacitor coupled to the storage terminal.

16. The power management circuit according to claim 14, wherein the common operation mode is configured to have a pre-charge period and a switch charging period; during the pre-charge period the storage voltage rises to a pre-charge voltage at a preset slope and during the switch charging period the storage voltage rises to the first storage preset value at a changing slope.

17. The power management circuit according to claim 14, wherein the bypass mode is configured to have a pre-charge period and a bypass charging period, during the pre-charge period the storage voltage rises to the second storage preset value at a preset slope and during the bypass charging period the storage voltage is maintained at the second storage preset value.

18. The power management circuit according to claim 14, wherein the power management circuit is configured to convert the storage voltage having the first storage preset value into the bus voltage if the bus voltage decreases in the common operation mode.

19. The power management circuit according to claim 14, wherein the power management circuit is configured to convert the storage voltage having the second storage preset value into the bus voltage if the bus voltage decreases in the bypass mode.

20. The power management circuit according to claim 14, wherein the power management circuit is configured to convert the storage voltage into the second storage preset value based on the sensing signal and a reference voltage in the bypass mode.

21. The power management circuit according to claim 14, wherein the power management circuit is configured to comprise:
a pre-charge circuit, configured to be coupled between the bus terminal and the storage terminal;
a switching circuit, configured to be coupled between the bus terminal and the storage terminal.
